(19) United States
(12) Patent Application Publication
(10) Pub. No.: US 2008/0023665 A1
(43) Pub. Date: Jan. 31, 2008

(54) Thermal interconnect and interface materials, methods of production and uses thereof

(76) Inventors: Martin W. Weiser, Liberty Lake, WA (US); Ravi Rastogi, Liberty Lake, WA (US); Meghana Nerurkar, Melville Park (SG); Devesh Mathur, Greenacres, WA (US); Colin Xingcun Tong, Greenacres, WA (US)

Correspondence Address: BUCHALTER NEMER, 18400 VON KARMAN AVE., SUITE 800, IRVINE, CA, 92612, US

(21) Appl. No.: 11/493,788

(22) Filed: Jul. 25, 2006

(51) Int. Cl. C09K 5/00

(52) U.S. Cl. 252/71

(57) ABSTRACT

Components and materials, including thermal interface materials, described herein include at least one matrix component, at least one high conductivity component, and at least one solder material. In some embodiments, the at least one high conductivity component includes a filler component, a lattice component or a combination thereof. Methods are also described herein of producing a thermal interface material that include providing at least one matrix component, providing at least one high conductivity component, providing at least one solder material, and blending the at least one matrix component, the at least one high conductivity component and the at least one solder material.

### FIELD OF THE INVENTION

The field of the invention is thermal interconnect systems, thermal interface systems and interface materials in electronic components, semiconductor components and other related layered materials applications.

### BACKGROUND

Electronic components are used in ever increasing numbers in consumer and commercial electronic products. Examples of some of these consumer and commercial products are televisions, flat panel displays, personal computers, gaming systems, Internet servers, cell phones, pagers, palm-type organizers, portable radios, car stereos, or remote controls. As the demand for these consumer and commercial electronics increases, there is also a demand for those same products to become smaller, more functional, and more portable for consumers and businesses.

As a result of the size decrease in these products, the components that comprise the products must also become smaller. Examples of some of those components that need to be reduced in size or scaled down are printed circuit or wiring boards, resistors, wiring, keyboards, touch pads, and chip packaging. Products and components also need to be prepackaged, such that the product and/or component can perform several related or unrelated functions and tasks. Examples of some of these “total solution” components and products comprise layered materials, mother boards, cellular and wireless phones and telecommunications devices and other components and products, such as those found in U.S. patent and PCT Application Serial Nos.: 60/396,294 filed Jul. 15, 2002, 60/294,433 filed May 30, 2001, Ser. No. 10/519,337 filed Dec. 22, 2004, Ser. No. 10/551,305 filed Sep. 28, 2005, Ser. No. 10/465,968 filed Jun. 26, 2003 and PCT/US02/17331 filed May 30, 2002, which are all commonly owned and incorporated herein in their entirety.

Components, therefore, are being broken down and investigated to determine if there are better building materials and methods that will allow them to be scaled down and/or combined to accommodate the demands for smaller electronic components. In layered components, one goal appears to be decreasing the number of the layers while at the same time increasing the functionality and durability of the remaining layers and surface/support materials. This task can be difficult, however, given that several of the layers and components of the layers should generally be present in order to operate the device.

Also, as electronic devices become smaller and operate at higher speeds, energy emitted in the form of heat increases dramatically with heat flux often exceeding 100 W/cm². A popular practice in the industry is to use thermal grease, or grease-like materials, alone or on a carrier in such devices to transfer the excess heat dissipated across physical interfaces. Most common types of thermal interface materials are thermal greases, phase change materials, and elastomer tapes. Thermal greases or phase change materials have lower thermal resistance than elastomer tape because of the ability to be spread in very thin layers and provide intimate thermal contact between adjacent surfaces. Typical thermal impedance values range between 0.05-1.6° C.-cm²/W. However, a serious drawback of thermal grease is that thermal performance deteriorates significantly after thermal cycling, such as from −65° C. to 150° C., or after power cycling when used in VLSI chips. The most common thermal greases use silicone oils as the carrier. It has also been found that the performance of these materials deteriorates when large deviations from surface planarity cause gaps to form between the mating surfaces in the electronic devices or when large gaps between mating surfaces are present for other reasons, such as manufacturing tolerances, etc. When the heat transferability of these materials breaks down, the performance of the electronic device in which they are used is adversely affected.

Thus, there is a continuing need to: a) design and produce thermal interconnects and thermal interface materials, layered materials, components and products that meet customer specifications while minimizing the size of the device and number of layers; b) produce more efficient and better designed materials, products and/or components with respect to the compatibility requirements of the material, component or finished product; c) produce materials and layers that are more compatible with other layers, surfaces and support materials at the interface of those materials; d) develop reliable methods of producing desired thermal interconnect materials, thermal interface materials and layered materials and components/products comprising contemplated thermal interface and layered materials; e) develop materials that possess a high thermal conductivity and a high mechanical compliance; and f) effectively reduce the number of production steps necessary for a package assembly, which in turn results in a lower cost of ownership over other conventional layered materials and processes.

### SUMMARY

Components and materials, including thermal interface materials, described herein comprise at least one matrix component, at least one high conductivity component, and at least one solder material. In some embodiments, the at least one high conductivity component comprises a filler component, a lattice component or a combination thereof.

Methods are also described herein of producing a thermal interface material that include providing at least one matrix component, providing at least one high conductivity component, providing at least one solder material, and blending the at least one matrix component, the at least one high conductivity component and the at least one solder material.

### BRIEF DESCRIPTION OF THE FIGURES

FIG. 1 shows a contemplated embodiment of a stacked or layered component comprising a thermal interface material, wherein the material comprises at least one high conductivity component, at least one matrix component and a solder material.

FIG. 2 shows data collected in graphical form that represents frequency (%) versus size for different silver particles.

FIG. 3 shows a contemplated embodiment of a stacked or layered component comprising a thermal interface material comprising a high conductivity component, which comprises a screen/cloth which is impregnated with a solder paste.

FIG. 4 shows a contemplated embodiment comprising a lattice component that has been either pressed or rolled.

### DETAILED DESCRIPTION

A suitable interface material or component should conform to the mating surfaces (deforms to fill surface contours and “wets” the surface), possess a low bulk thermal resistance and possess a low thermal contact resistance. Bulk thermal resistance can be expressed as a function of the material's or component's thickness, thermal conductivity and area. Thermal contact resistance is a measure of how well a material or component is able to transfer heat across the interface which is largely determined by the amount and type of contact between the two materials. One of the goals of the materials and methods described herein is to minimize thermal contact resistance without a significant loss of performance from the materials. The thermal resistance of an interface material or component can be shown as follows:

Θinterface=t/k+2Θ_{contact} Equation 1
where
   Θ is the thermal resistance,
   t is the material thickness,
   k is the thermal conductivity of the material

The term “t/k” represents the thermal resistance of the bulk material and “2Θ_{contact}” represents the thermal contact resistance at the two surfaces. A suitable interface material or component should have a low bulk resistance and a low thermal contact resistance, i.e. at the mating surface.

Many electronic and semiconductor applications require that the interface material or component accommodate deviations from surface flatness resulting from manufacturing and/or warpage of components because of coefficient of thermal expansion (CTE) mismatches.

A material with a low value for k, such as thermal grease, performs well if the interface is thin, i.e. the “t” value is low. If the interface thickness increases by as little as 0.002 inches, the thermal performance can drop dramatically. Also, for such applications, differences in CTE between the mating components cause the gap to expand and contract due to warpage with each temperature or power cycle. This variation of the interface thickness can cause pumping of fluid interface materials (such as grease) away from the interface.

Interfaces with a larger area are more prone to deviations from surface planarity as manufactured. To optimize thermal performance, the interface material should be able to conform to non-planar surfaces and thereby achieve lower thermal contact resistance. As used herein, the term “interface” means a couple or bond that forms the common boundary between two parts of matter or space, such as between two molecules, two backbones, a backbone and a network, two networks, etc. An interface may comprise a physical attachment of two parts of matter or components or a physical attraction between two parts of matter or components, including bond forces such as covalent and ionic bonding, Van der Waals, diffusion bonding, hydrogen bonding and non-bond forces such as electrostatic, coulombic, and/or magnetic attraction. Contemplated interfaces include those interfaces that are formed with bond forces, such as covalent and metallic bonds; however, it should be understood that any suitable adhesive attraction or attachment between the two parts of matter or components is preferred.

Optimal interface materials and/or components possess a high thermal conductivity and a high mechanical compliance, e.g. will yield elastically or plastically at the local level when force is applied. High thermal conductivity reduces the first term of Equation 1 while high mechanical compliance reduces the second term. The layered interface materials and the individual components of the layered interface materials described herein accomplish these goals. When properly produced, the thermal interface component described herein will span the distance between the mating surfaces, e.g. that of the heat spreader material and the silicon die component, thereby allowing a continuous high conductivity path from one surface to the other surface.

As mentioned earlier, several goals of thermal interface materials, layered interface materials and individual components described herein are to: a) design and produce thermal interconnects and thermal interface materials, layered materials, components and products that meet customer specifications while minimizing the size of the device and number of layers; b) produce more efficient and better designed materials, products and/or components with respect to the compatibility requirements of the material, component or finished product; c) produce materials and layers that are more compatible with other layers, surfaces and support materials at the interface of those materials; d) develop reliable methods of producing desired thermal interconnect materials, thermal interface materials and layered materials and components/products comprising contemplated thermal interface and layered materials; e) develop materials that possess a high thermal conductivity and a high mechanical compliance; and f) effectively reduce the number of production steps necessary for a package assembly, which in turn results in a lower cost of ownership over other conventional layered materials and processes.

Materials and modified surfaces/support materials for pre-attached/pre-assembled and stand alone thermal solutions and/or IC (interconnect) packages are provided herein. In addition, thermal solutions and/or IC packages that comprise one or more of these materials and modified surface/support materials described herein are contemplated. Ideally, contemplated components of a suite of thermal interface materials exhibit low thermal resistance for a wide variety of interface conditions and demands. Thermal interface materials contemplated herein can be used to attach the heat generating electronic devices (e.g. the computer chip) to the heat dissipating structures (e.g. heat spreaders, heat sinks). The performance of the thermal interface materials is one of the most important factors in ensuring adequate and effective heat transfer in these devices. The thermal interface materials described herein are novel in that they combine components in amounts not yet contemplated or disclosed in other related art.

As mentioned, the thermal interface materials and modified surfaces described herein, which are also described in US patent application entitled “Synergistically-Modified Surfaces and Surface Profiles for Use With Thermal Interconnect and Interface Materials, Methods of Production and Uses Thereof”, which is commonly-owned and incorporated herein by reference in its entirety, may be utilized in total solution packaging, such as in a combo-spreader or layered component. The layered interface materials and the individual components of the layered interface materials described herein accomplish these goals.

Thermal interface materials comprise at least one matrix material, at least one high conductivity component and at least one solder material. As used herein, “high conductivity component” means that the component comprises a thermal conductivity of greater than about 20 and in some embodiments, at least about 40 W/m-° C. Optimally, it is desirable to have at least one high conductivity component of not less than about 80 W/m-° C. thermal conductivity. Methods of forming these thermal interface materials comprise providing each of the at least one matrix material, at least one high conductivity component and at least one solder material, blending the components and optionally curing the components pre- or post-application of the thermal interface material to the surface, substrate or component.

In addition, it is important for thermal interface materials described herein to exhibit lower thermal impedance once the material is cured. For example, the thermal interface materials described herein will comprise a pre-cure state, a cured state or some combination thereof depending on the progression of the curing process. The thermal impedance for the pre-cure state is considered the benchmark or reference for comparing thermal impedance at a later state. The thermal impedance of the cured state of a contemplated thermal interface material should be reduced by at least 25% as compared to the pre-cure state. In some embodiments, the thermal impedance of the cured state of a contemplated thermal interface material should be reduced by at least 40% as compared to the pre-cure state. In yet other embodiments, the thermal impedance of the cured state of a contemplated thermal interface material should be reduced by at least 70% as compared to the pre-cure state.

The at least one matrix material may comprise organic oils, the organic component of the Honeywell PCM series including PCM45 and/or PCM45F, which is a high conductivity phase change material manufactured by Honeywell International Inc., or curable and/or crosslinkable polymers. The at least one additional material may comprise metal and metal-based materials, such as those manufactured by Honeywell International Inc., such as solders, connected to Ni, Cu, Al, AlSiC, copper composites, CuW, diamond, graphite, SiC, carbon composites and diamond composites which are classified as heat spreaders or those materials that work to dissipate heat. The at least one matrix material is chosen based on the application. For example, at least one organic oil may be utilized in order to provide the thermal interface material with better gap-filling properties. At least one phase change material may be utilized in order to provide a more versatile matrix material, which can easily transform from soft gel to compliant material. Crosslinkable polymers may also be utilized in order to provide a matrix material that can be strategically cured to provide a stable layered material, along with superior heat transferability properties. Contemplated matrix materials comprise silicone-based polymers, silicone oils, and organic oils, alone or in combination. In some embodiments, contemplated oils comprise plant-based oils (e.g. corn oil), mineral oils and synthetic oils, such as MIDEL 1731, which has properties close to silicone/mineral oil. Organic oils can in many cases have similar properties as thermal greases. However, many organic oils will partially cure upon heating which will slow or prevent the pump-out that the silicone based greases experience.

Phase-change materials that are contemplated herein comprise waxes, polymer waxes or mixtures thereof, such as paraffin wax. Paraffin waxes are a mixture of solid hydrocarbons having the general formula CₙH₂ₙ₊₂ and having melting points in the range of about 20° C. to 145° C. Examples of some contemplated melting points are about 45° C. and 60° C. Thermal interface components that have melting points in this range are PCM45 and PCM60HD—both manufactured by Honeywell International Inc. Polymer waxes are typically polyethylene waxes, polypropylene waxes, and have a range of melting points from about 40° C. to 160° C.

PCM45 comprises a thermal conductivity of about 3.0 W/m-K, a thermal resistance of about 0.25° C.-cm²/W at 0.05 mm thickness, is typically applied at a thickness of about 0.010 inches (0.254 mm) and comprises a soft material above the phase change temperature of approximately 45° C., flowing easily under an applied pressure of about 5 to 30 psi. Typical characteristics of PCM45 are a) a super high packaging density—over 80 weight %, b) a conductive filler, c) extremely low thermal resistance, and as mentioned earlier d) about a 45° C. phase change temperature. PCM60HD comprises a thermal conductivity of about 5.0 W/m-K, a thermal resistance of about 0.17° C.-cm²/W, is typically applied at a thickness of about 0.0015 inches (0.04 mm) and comprises a soft material, flowing easily under an applied pressure of about 5 to 30 psi. Typical characteristics of PCM60HD are a) a super high packaging density—over 80 weight %, b) a conductive filler, c) extremely low thermal resistance, and as mentioned earlier d) about a 60° C. phase change temperature. TM200 (a thermal interface component not comprising a phase change material and manufactured by Honeywell International Inc.) comprises a thermal conductivity of about 3.0 W/m-K, a thermal resistance of below 0.20° C.-cm²/W, is typically applied at a thickness of about 0.002 inches (0.05 mm) and comprises a paste that can be thermally cured to a soft gel. Typical characteristics of TM200 are a) a super high packaging density—over 80 weight %, b) a conductive filler, c) extremely low thermal resistance, d) about a 125° C. curing temperature, and e) dispensable silicone-based thermal gel. PCM45F comprises a thermal conductivity of about 2.35 W/m-K, a thermal resistance of about 0.20° C.-cm²/W, is typically applied at a thickness of about 0.050 mm [application thickness is generally 0.2-0.25 mm (8-10 mil), but it normally compresses to 0.05 mm (2 mil)] and comprises a soft material, flowing easily under an applied pressure of about 5 to 40 psi. Typical characteristics of PCM45F are a) a super high packaging density—over 80 weight %, b) a conductive filler, c) extremely low thermal resistance, and as mentioned earlier d) about a 45° C. phase change temperature.

Phase change materials are useful in thermal interface component applications because they are solid at room temperature and can easily be pre-applied to thermal management components. At operation temperatures above the phase change temperature, the material is liquid and behaves like a thermal grease. The phase change temperature is the melting temperature where the material transforms from a soft solid at low temperatures to a viscous liquid at higher temperatures.

Paraffin-based phase change materials, however, have several drawbacks. On their own, they can be very fragile and difficult to handle. They also tend to squeeze out of a gap from the device in which they are applied during thermal cycling, very much like grease. The rubber-resin modified paraffin polymer wax system described herein avoids these problems and provides significantly improved ease of handling, is capable of being produced in flexible tape or solid layer form, and does not pump out or exude under pressure. Although the rubber-resin-wax mixtures may have the same or nearly the same melt temperature, their melt viscosity is much higher and they do not migrate easily. Moreover, the rubber-wax-resin mixture can be designed to be self-crosslinking, which ensures elimination of the pump-out problem in certain applications. Examples of contemplated phase change materials are malenized paraffin wax, polyethylene-maleic anhydride wax, and polypropylene-maleic anhydride wax. The rubber-resin-wax mixtures will functionally form at a temperature between about 50 to 150° C. to form a crosslinked rubber-resin network.

Resin-containing interface materials and solder materials, especially those comprising silicone resins, that may also have appropriate thermal fillers can exhibit a thermal resistance of less than 0.5° C.-cm²/W. Unlike thermal grease, thermal performance of the material will not degrade after thermal cycling or flow cycling in IC devices because liquid silicone resins will cross link to form a soft gel upon heat activation.

Interface materials and polymer solders comprising resins, such as silicone resins, will not be “squeezed out” as thermal grease can be in use and will not display interfacial delamination during thermal cycling. The new material can be provided as a dispensable liquid paste to be applied by dispensing methods and then cured as desired. It can also be provided as a highly compliant, cured, and possibly cross-linkable elastomer film or sheet for pre-application on interface surfaces, such as heat sinks.

The resin mixture can be cured either at room temperature or at elevated temperatures to form a compliant elastomer. The reaction is via catalyzed hydrosilylation (addition cure) of vinyl-functional siloxanes by hydride-functional siloxanes in the presence of a catalyst, such as platinum complexes or nickel complexes. In some embodiments, contemplated platinum catalysts comprise GELEST SIP6830.0, SIP6832.0, and platinum-vinylsiloxane.

Contemplated examples of vinyl silicone include vinyl terminated polydimethyl siloxanes that have a molecular weight of about 10000 to 50000. Contemplated examples of hydride functional siloxane include methylhydrosiloxane-dimethylsiloxane copolymers that have a molecular weight about 500 to 5000. Physical properties can be varied from a very soft gel material at a very low crosslink density to a tough elastomer network of higher crosslink density.

The at least one high conductivity component may be dispersed in the thermal interface component or mixture should advantageously have a high thermal conductivity. The at least one high conductivity component may comprise a filler component, a lattice component or a combination thereof. As used herein, the phrase “lattice component” means those high conductivity components which are layered or woven, such as mesh or fabric. As used herein, the phrase “filler component” means those high conductivity components which are not lattice components.

Suitable high conductivity components include silver, copper, aluminum, and alloys thereof; boron nitride, aluminum spheres, aluminum nitride, silver coated copper, silver coated aluminum, carbon fibers, and carbon fibers coated with metals, metal alloys, conductive polymers or other composite materials. Combinations of boron nitride and silver or boron nitride and silver/copper also provide enhanced thermal conductivity. Boron nitride in amounts of at least 20 wt % and silver in amounts of at least about 60 wt % are particularly useful. These materials may also comprise metal flakes or sintered metal flakes. As mentioned earlier, it is contemplated that high conductivity components with a thermal conductivity of greater than about 20 and in some embodiments, at least about 40 W/m-° C. can be used. Optimally, it is desired to have a high conductivity component of not less than about 80 W/m⁻° C. thermal conductivity. In some embodiments, the high conductivity components comprise large silver powders (20 microns) from TECHNIC, small silver powders (1-3 microns) from METALOR, or a combination thereof.

In some embodiments, the at least one high conductivity component comprises at least one filler component, at least one lattice component or a combination thereof. In embodiments comprising at least one filler component, the at least one filler component may comprise at least one plurality of particles. In some embodiments, the at least one plurality of particles comprises at least one median diameter. In other embodiments, the at least one plurality of particles comprises a first plurality of particles having a first median diameter and a second plurality of particles having a second median diameter. Additional pluralities of particles having median diameters can also be incorporated into contemplated materials, as needed. In yet other embodiments, at least some of the pluralities of particles have a median diameter less than about 40 micrometers. In other embodiments, the median diameter of at least some of those pluralities of particles is less than about 30 micrometers. In yet other embodiments, the median diameter of at least some of those pluralities of particles is less than about 20 micrometers.

Contemplated high conductivity components also may comprise lattice components, such as screens, mesh, foam, cloth or combinations thereof. High conductivity foam may be considered either a filler component or a lattice component depending on how it is constructed. Contemplated mesh may comprise copper, silver, gold, indium, tin, aluminum, iron, screen, foam, cloth, graphite, carbon fibers or combinations thereof. Contemplated high conductivity components also comprise silver, copper, aluminum or alloys thereof, boron nitride, aluminum spheres, aluminum nitride, silver-coated copper, silver-coated aluminum, carbon fibers, carbon fibers coated with metals, carbon nanotubes, carbon nanofibers, metal alloys, conductive polymers or other composite materials, metal-coated boron nitride, metal-coated ceramics, diamond, metal-coated diamond, graphite, metal-coated graphite and combinations thereof.

In those embodiments that comprise at least one lattice component, the lattice component may be treated by rolling or pressing the component to increase the surface area of the high conductivity material, while lowering the free space between the high conductivity material. This process is further explained in the Examples section.

Thermal reinforcements, which are considered to be high conductivity components, comprise highly conductive metals, ceramics, composites, or carbon materials, such as low CTE materials or shape memory alloys. Metals or other highly conductive screens, mesh, cloths, or foams are used to enhance thermal conductivity, tailor CTE, adjust BLT, and/or modify modulus and thermal fatigue life of the TIM. Examples include Cu, Al and Ti foam (e.g. 0.025 to 1.5 mm pore size with 30-90 vol % porosity from Mitsubishi), Cu or Ag mesh or screen (e.g. wire diameter 0.05-0.15 mm, 100-145 mesh from McNichols Co), or carbon/graphite cloth (e.g. 5.7 oz/yd² plain weave, 0.010″ thick, from US Composites).

The thermal reinforcement can be treated in a number of ways to improve the performance of the TIM. The reinforcement can be pressed or rolled to reduce the thickness and in doing so reduce the bond line thickness (“BLT”), while also increasing the area density of the reinforcement, this is particularly effective with Cu screen as shown above. The surface of the reinforcement can be treated to slow the formation of intermetallic compounds due to reaction with the solder component (e.g. plating a Cu mesh with Ni). It can also be treated to enhance the wetting of the reinforcement by the solder component (e.g. Ni plating of carbon/graphite cloth or removal of oxides by methods such as exposure to forming gas (hydrogen in nitrogen or argon) at elevated temperature, wash with an acid, or coating with a flux). A flexible frame (e.g. polymer, carbon/graphite, ceramic, metal, composite or other flexible frame) can be used to divide the TIM area into smaller areas that behave independently from their neighbors to compensate for interfacial shear loading issues due to CTE mismatch effects with large size die.

High conductivity components may be coated utilizing any suitable method or apparatus, including coating the high conductivity components with solder in the molten state, by coating utilizing plasma spray, by plating or by a combination thereof.

A suitable interface material can also be produced/prepared that comprises a solder material. The solder material may comprise any suitable solder material or metal, such as indium, silver, copper, aluminum, tin, bismuth, lead, gallium and alloys thereof, but it is preferred that the solder material comprise indium or indium-based alloys.

Solder materials that are dispersed in the resin mixture are contemplated to be any suitable solder material for the desired application. Preferred solder materials are indium tin (InSn) alloys, indium silver (InAg) alloys, indium-bismuth (InBi) alloys, tin indium bismuth (SnInBi), indium tin silver zinc (InSnAgZn), indium-based alloys, tin silver copper alloys (SnAgCu), tin bismuth and alloys (SnBi), and gallium-based compounds and alloys. Especially preferred solder materials are those materials that comprise indium. The solder may or may not be doped with additional elements to promote wetting to the heat spreader or die backside surfaces.

In some embodiments, the bismuth-tin alloys comprise less than about 60 weight percent (wt %) of tin. In other embodiments, the bismuth-tin alloys comprise between about 30 and 60 wt % of tin. In some embodiments, the tin-indium-bismuth alloys comprise less than about 80 wt % of tin, less than about 50 wt % of indium and less than about 15 wt % of bismuth. In other embodiments, the tin-indium-bismuth alloys comprise between about 30-80 wt % of tin, between about 1-50 wt % of indium and about 1-70 wt % of bismuth. In some embodiments, indium-tin-silver-zinc alloys comprise less than 65 wt % of indium, less than about 65 wt % of tin, less than about 10 wt % of silver and less than about 10 wt % of zinc. In other embodiments, indium-tin-silver-zinc alloys comprise about 35-65 wt % of indium, about 35-65 wt % of tin, about 1-10 wt % of silver and about 1-10 wt % of zinc.

Additional contemplated solder compositions are as follows: InSn=52% In (by weight) and 48% Sn (by weight) with a melting point of 118° C.; InAg=97% In (by weight) and 3% Ag (by weight) with a melting point of 143° C.; In=100% indium (by weight) with a melting point of 157° C.; SnAgCu=94.5% tin (by weight), 3.5% silver (by weight) and 2% copper (by weight) with a melting point of 217° C.; SnBi=60% Tin (by weight) and 40% bismuth (by weight) with a melting range of 139-170° C., SnInBi=60% Sn (by weight), 35% In (by weight), and 5% Bi (by weight) with a melting range of 93-140° C., and InSnAgZn=50% In (by weight), 46% Sn (by weight), 2% Ag (by weight) and 2% Sn (by weight) with a melting temperature of 118° C. It should be appreciated that other compositions comprising different component percentages can be derived from the subject matter contained herein.

As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include indium, silver, copper, aluminum, tin, bismuth, lead, gallium and alloys thereof, silver coated copper, and silver coated aluminum. The term “metal” also includes alloys, metal/metal composites, metal ceramic composites, metal polymer composites, as well as other metal composites. As used herein, the term “compound” means a substance with constant composition that can be broken down into elements by chemical processes. As used herein, the phrase “metal-based” refers to any coating, film, composition or compound that comprises at least one metal.

In some embodiments, the at least one solder material comprises at least one plurality of particles. In some embodiments, the at least one plurality of particles comprises at least one median diameter. In other embodiments, the at least one plurality of particles comprises a first plurality of particles having a first median diameter and a second plurality of particles having a second median diameter. Additional pluralities of particles having median diameters can also be incorporated into contemplated materials, as needed. In yet other embodiments, at least some of the pluralities of particles have a median diameter less than about 40 micrometers. In other embodiments, the median diameter of at least some of those pluralities of particles is less than about 30 micrometers. In yet other embodiments, the median diameter of at least some of those pluralities of particles is less than about 20 micrometers.

The solder-based interface materials, as described herein, have several advantages directly related to use and component engineering, such as: a) high bulk thermal conductivity, b) metallic bonds may be formed at the joining surfaces, lowering thermal contact resistance c) the interface solder material can be easily incorporated into micro components, components used for satellites, and small electronic components.

The thermal interface materials that comprise solder, solder paste, or a polymer solder hybrid such as in Example 1 and 2, and high conductivity component, which includes reinforcement materials, help to contribute to superior performance of the thermal interface material. Performance benefits include (a) adjustable BLT and tailorable CTE making the TIM suitable for die from 2 to 20 mm on a side (b) excellent metallurgical surface wetting that minimizes interface thermal contact thermal resistance; (c) controlled hybrid structure and reinforcement property leads to exceptional, consistent and uniform thermal performance ensuring long term reliability; and (d) unmatched thermal performance, low cost and ease-of-application. Serving as the interface heat transfer material for electronic components, contemplated thermal interface materials would typically be applied to microprocessors, telecom and RF devices, power semiconductors, and insulated gate bipolar transistors (IGBTs).

An additional component, such as a plurality of low modulus metal-coated polymer spheres or microspheres may be added to the solder material to decrease the bulk elastic modulus of the solder. An additional component may also be added to the solder to promote wetting to the die and/or heat spreader surface. These additions are contemplated to be silicide formers, or elements that have a higher affinity for oxygen or nitrogen than does silicon. The additions can be one element that satisfies all requirements, or multiple elements each of which has one advantage. Additionally, alloying elements may be added which increase the solubility of the dopant elements in the indium or solder matrix.

Vapor grown carbon fibers and other fillers, such as substantially spherical filler particles may be incorporated. Additionally, substantially spherical shapes or the like will also provide some control of the thickness during compaction. Dispersion of filler particles can be facilitated by the addition of functional organometallic coupling agents or wetting agents, such as organosilane, organotitanate, organozirconium, etc. Typical particle sizes useful for fillers in the resin material may be in the range of about 1-20 μm with a maximum of about 100 μm.

These compounds may comprise at least some of the following: at least one silicone compound in 1 to 20 weight percent, organotitanate in 0-10 weight percent, at least one solder material in 5 to 95 weight percent, at least one high conductivity filler in 0-90 weight percent. These compounds may include one or more of the optional additions, e.g., wetability enhancer. The amounts of such additions may vary but, generally, they may be usefully present in the following approximate amounts (in wt. %): filler up to 95% of total (filler plus resins); wetability enhancer 0.1 to 5% (of total), and adhesion promoters 0.01 to 1% (of total). It should be noted that the addition of at least about 0.5% carbon fiber significantly increases thermal conductivity. These compositions are described in U.S. Pat. No. 6,706,219, U.S. application Ser. No. 10/775,989 filed on Feb. 9, 2004 and PCT Serial No.: PCT/US02/14613, which are all commonly owned and incorporated herein in their entirety by reference.

The solder-based interface materials, such as polymer solder materials, polymer solder hybrid materials, advanced polymer solder materials and other solder-based interface materials, as described herein, have several advantages directly related to use and component engineering, such as: a) the interface material/polymer solder material can be used to fill small gaps on the order of 0.2 millimeters or smaller, b) the interface material/polymer solder material can efficiently dissipate heat in those very small gaps as well as larger gaps, unlike most conventional solder materials, and c) the interface material/polymer solder material can be easily incorporated into micro components, components used for satellites, and small electronic components.

The contemplated thermal interface component can be provided as a dispensable paste to be applied by dispensing methods (such as screen printing, stencil printing, or automated dispensing) and then cured as desired. It can also be provided as a highly compliant, cured, elastomer film or sheet for pre-application on interface surfaces, such as heat sinks. It can further be provided and produced as a soft gel or liquid that can be applied to surfaces by any suitable dispensing method, such as screen-printing or ink jet printing. Even further, the thermal interface component can be provided as a tape that can be applied directly to interface surfaces or electronic components.

Thermal interface materials and related layers can be laid down in any suitable thickness, depending on the needs of the electronic component, and the vendor as long as the thermal interface component is able to sufficiently perform the task of dissipating some or all of the heat generated from the surrounding electronic component. Contemplated thicknesses comprise thicknesses in the range of about 0.050-0.100 mm. In some embodiments, contemplated thicknesses of thermal interface materials are within the range of about 0.030-0.150 mm. In other embodiments, contemplated thicknesses of thermal interface materials are within the range of about 0.010-0.250 mm.

When using a metallic thermal interface material, like solder, which has a high elastic modulus compared to most polymer systems, it may be necessary to reduce the coefficient of thermal expansion mismatch generated mechanical stresses transferred to the semiconductor die in order to prevent cracking of the die. This stress transfer can be minimized by increasing the bondline thickness of the metallic thermal interface material, reducing the coefficient of thermal expansion of the heat spreader, or changing the geometry of the heat spreader to minimize stress transfer. Increasing the bondline thickness generally increases the thermal resistance of the interface, but including a high conductivity mesh as part of the thicker TIM as disclosed in this application can minimize this increase and even result in lower thermal resistance than for the TIM alone. Examples of lower coefficient of thermal expansion (CTE) materials are AlSiC, CuSiC, copper-graphite composites, carbon-carbon composites, diamond, CuMoCu laminates, etc. Examples of geometric changes are adding a partial or through slot to the spreader to decrease spreader thickness and forming a truncated, square based, inverted pyramid shape to lower stress and stiffness by having the spreader cross-section be lower near the semiconductor die.

As mentioned, the at least one thermal interface material may be coupled with a metal-based coating, layer and/or film. In contemplated embodiments, metal-based coating layers may comprise any suitable metal that can be laid down on the surface of the thermal interface material or surface/support material in a layer. In some embodiments, the metal-based coating layer comprises indium, such as from indium metal, In33Bi, In33BiGd and In3Ag and can also include nickel, silver, and/or gold. These metal-based coating layers are generally laid down by any method capable of producing a uniform layer with a minimum of pores or voids and can further lay down the layer with a relatively high deposition rate. Many suitable methods and apparatus are available to lay down layers or ultra thin layers of this type, such as spot plating or pulsed plating. Pulsed plating (which is intermittent plating as opposed to direct current plating) can lay down layers that are free or virtually free of pores and/or voids.

In some contemplated embodiments, thermal interface material can be directly deposited onto at least one of the sides of the heat spreader component, such as the bottom side, the top side or both. In some contemplated embodiments, the thermal interface material is silk screened, stencil printed, screen printed or dispensed directly onto the heat spreader by methods such as jetting, thermal spray, liquid molding or powder spray. In yet other contemplated embodiments, a film of thermal interface material is deposited and combined with other methods of building adequate thermal interface material thickness, including direct attachment of a preform or silk screening of a thermal interface material paste.

Methods of forming layered thermal interface materials and thermal transfer materials include: a) providing a heat spreader component, wherein the heat spreader component comprises a top surface, a bottom surface and at least one heat spreader material; b) providing at least one thermal interface material, such as those described herein, wherein the thermal interface material is directly deposited onto the bottom surface of the heat spreader component; c) depositing, applying or coating a metal-based coating, film or layer on at least part of the bottom surface of the heat spreader component; d) depositing, applying or coating the at least one thermal interface material onto at least part of at least one of the surfaces of the heat spreader component, and e) bringing the bottom of the heat spreader component with the thermal interface material into contact with the heat generating device, generally a semiconductor die.

Once deposited, applied or coated, the thermal interface material layer comprises a portion that is directly coupled to the heat spreader material and a portion that is exposed to the atmosphere, or covered by a protective layer or film that can be removed just prior to installation of the heat spreader component. Additional methods include providing at least one adhesive component and coupling the at least one adhesive component to at least part of at least one of the surfaces of the at least one heat spreader material and/or to or in at least part of the thermal interface material. At least one additional layer, including a substrate layer, can be coupled to the layered interface material.

As described herein, optimal interface materials and/or components possess a high thermal conductivity and a high mechanical compliance, e.g. will yield elastically or plastically on a local level when force is applied. In some embodiments, optimal interface materials and/or components will possess a high thermal conductivity and good gap-filling properties. High thermal conductivity reduces the first term of Equation 1 while high mechanical compliance reduces the second term. The layered interface materials and the individual components of the layered interface materials described herein accomplish these goals. When properly produced, the thermal interface component described herein will span the distance between the mating surfaces of the heat producing device and the heat spreader component thereby allowing a continuous high conductivity path from one surface to the other surface. Suitable thermal interface components comprise those materials that can conform to the mating surfaces, possess a low bulk thermal resistance and possess a low thermal contact resistance.

Pre-attached/pre-assembled thermal solutions and/or IC (interconnect) packages comprise one or more components of the thermal interface materials described herein and at least one adhesive component. These thermal interface materials exhibit low thermal resistance for a wide variety of interface conditions and demands. As used herein, the term “adhesive component” means any substance, inorganic or organic, natural or synthetic, that is capable of bonding other substances together by surface attachment. In some embodiments, the adhesive component may be added to or mixed with the thermal interface material, may actually be the thermal interface material or may be coupled, but not mixed, with the thermal interface material. Examples of some contemplated adhesive components comprise double-sided tape from SONY, such as SONY T4411 or SONY T4100D203, or from 3M such as 3M F9460PC. In other embodiments, the adhesive may serve the additional function of attaching the heat spreading component to the package substrate independent of the thermal interface material.

Contemplated thermal interface materials, along with layered thermal interface materials and components may then be applied to a substrate, another surface, or another layered material. The electronic component may comprise, for example, a thermal interface material, a substrate layer and an additional layer. Substrates contemplated herein may comprise any desirable substantially solid material. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polyimide. The “substrate” may even be defined as another polymer material when considering cohesive interfaces. In more preferred embodiments, the substrate comprises a material common in the packaging and circuit board industries such as silicon, copper, glass, and another polymer.

Additional layers of material may be coupled to the thermal interface materials or layered interface materials in order to continue building a layered component or printed circuit board. It is contemplated that the additional layers will comprise materials similar to those already described herein, including metals, metal alloys, composite materials, polymers, monomers, organic compounds, inorganic compounds, organometallic compounds, resins, adhesives and optical wave-guide materials.

Several methods and many thermal interface materials can be utilized to form these pre-attached/pre-assembled thermal solution components. A method for forming the thermal solution/package and/or IC package includes: a) providing the thermal interface material or layered interface material described herein; b) providing at least one adhesive component; c) providing at least one surface or substrate; d) coupling the at least one thermal interface material and/or layered interface material with the at least one adhesive component to form an adhesive unit; e) coupling the adhesive unit to the at least one surface or substrate to form a thermal package; f) optionally coupling an additional layer or component to the thermal package.

Applications of the contemplated thermal solutions, IC packages, thermal interface components, layered interface materials and heat spreader components described herein comprise incorporating the materials and/or components into another layered material, an electronic component or a finished electronic product. Electronic components, as contemplated herein, are generally thought to comprise any layered component that can be utilized in an electronic-based product. Contemplated electronic components comprise circuit boards, chip packaging, separator sheets, dielectric components of circuit boards, printed-wiring boards, and other components of circuit boards, such as capacitors, inductors, and resistors.

### EXAMPLES

The information presented herein in the Examples section should be utilized by one of ordinary skill in the art to understand the breadth and application of the subject matter disclosed herein. Some of this information is also presented in “Impact of Application Surface on The Development of Thermal Interface Materials” by Martin W. Weiser, Devesh Mathur and Ravi Rastogi for The Proceedings of the IMAPS 39^{th} International Symposium on Microelectronics, San Diego, Calif. Oct. 8-12, 2006, which is incorporated herein by reference in its entirety.

### TI and BLT Measurement

The thermal performance of the TIM was measured using a custom thermal impedance (TI) test system based upon ASTM D5470-06. The test blocks were made from oxygen free high conductivity (OFHC) copper rod 2.54 cm in diameter and 1.78 cm tall. The blocks each had three 1.18 mm diameter thermocouple holes drilled to the centerline from one side along their length to allow measurement of the temperature gradient. This permits calculation of the heat flux in the test stack and projection of the interface temperature where the test block meets the TIM being tested.

The TIM was spread on the top circular surface of the lower test block to a thickness of approximately 0.25 mm (0.010″) and two 50 μm spacers made from chromel wire were placed approximately 6 mm apart. The upper block was then positioned above the TIM and gently pressed into place. The test blocks were then loaded into the TI test system and the uncured thermal impedance was measured with a heater input of 140 W at a pressure of 276 kPa (40 psi).

After testing in the uncured condition, the TIM/block assembly was cured at 150° C. for 40 minutes with a dead weight load that yielded a 207 kPa (30 psi) pressure. They were then retested at 140 W and 276 kPa (40 psi) pressure.

The BLT was measured by measuring the difference in the height of the test block before and after assembly using a dial indicator.

### Example 1

Example 1 comprises an oil-based carrier as the matrix component, a high conductivity component and a solder material. The oil-based carrier matrix is beneficial in this composition because oil has a higher thermal conductivity as compared to air. The conductive matrix dramatically improves the thermal performance of the network of high conductivity component and solder compared to the same network filled with air. In addition, the oil-based carrier matrix is a non-curable matrix. Specifically, this contemplated formulation comprises edible oil, such as flaxseed oil from a nutritional supplement capsule. In addition, this contemplated formulation comprises 65.4% volume total metals loading, which may specifically comprise 16 micron Sn35In5Bi solder powder—46.4% volume, 1 micron silver powder—9.5% volume and 21 micron silver powder—9.5% volume. This contemplated thermal interface material is in the form of a soft paste, which is easily dispensable.

In order to activate the solder, a cure procedure is used, specifically; the thermal interface material is cured for 40 minutes at 150° C. under 30 psi pressure on the joint. The TI value of the thermal interface material is 0.075° C.-cm²/W at 0.004″ (0.100 mm) BLT when cured between gold-plated test blocks.

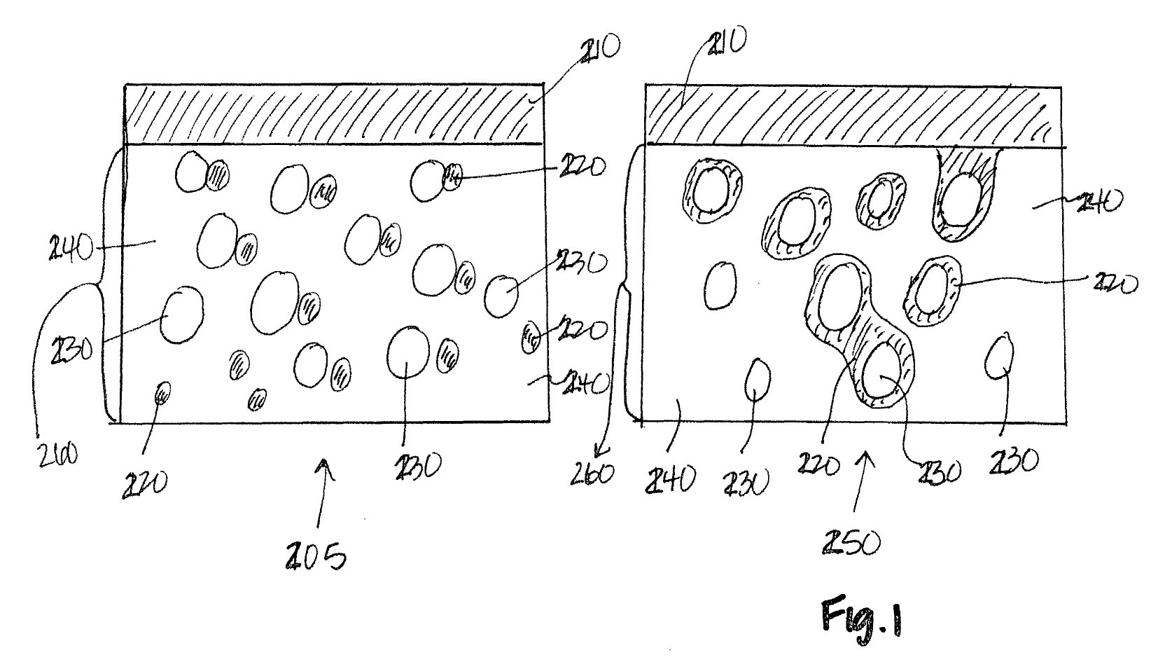

FIG. 1 shows a thermal interface material composed of a high conductivity component, a solder material, and a matrix material. In FIG. 1, the “before cure” (205) and “after cure” (250) embodiments are represented. In each embodiment, the heat spreader (210) is located above the thermal interface material (260). In the thermal interface material (260), one can see the matrix material (240), the high conductivity component (230) and the solder material (220). Note that in the after cure embodiment (250), the solder material (220) surrounds several of the plurality of high conductivity components (230), whereas others are left without contact with solder material.

### Example 2

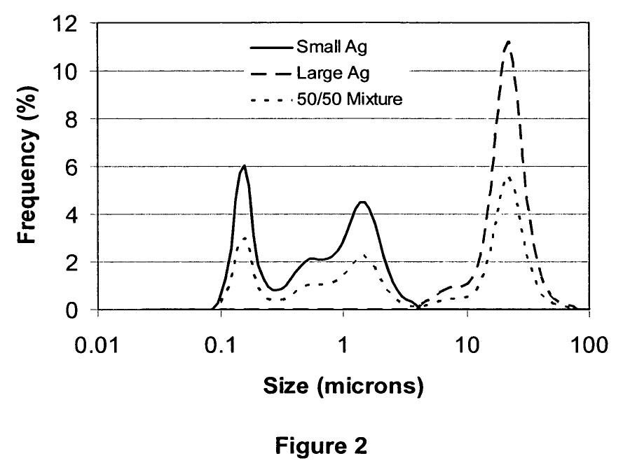

Example 2 comprises at least one polymer-based carrier as the matrix component, a high conductivity component and a solder material. Table 1 below describes some of the wide range of compositions that are possible along with the measured thermal impedance at a nominal BLT of 2 mils. The two solder powders were cast and gas atomized with an average particle size of 16-20 μm. The large silver powder is TECHNIC Inc. −500/+635 mesh with an average size of 21 μm while the small silver is METALOR Technologies USA K0082P with an average size of 1 μm. The large copper powder is the 635 grade from ACUPOWDER International with an average size of 15 μm while the small copper powder is the 2000 grade from ACUPOWDER International with an average size of 3 μm. FIG. 2 shows data collected in graphical form that represents the frequency (%) versus the size for representative samples from some of these different particle types.

| | | | | Large | Small | Large | Small | TI- | TI- | |
|---|---|---|---|---|---|---|---|---|---|---|
| | Polymer | Sn35In5Bi | In46Sn2Ag2Zn | Ag | Ag | Cu | Cu | Raw | Cure | BLT |
| Label | (vol %) | (vol %) | (vol %) | (vol %) | (vol %) | (vol %) | (vol %) | (C-cm2/W) | | (microns) |
| PSH 1 | 40.2% | 19.7% | | | | | 40.0% | 0.453 | 0.383 | 40 |
| PSH 2 | 35.7% | 53.4% | | | | | 10.9% | 0.268 | 0.074 | 42 |
| PSH 3 | 34.9% | 21.5% | | 43.7% | | | | 0.314 | 0.131 | 73 |
| PSH 4 | 39.6% | 19.9% | | | 40.5% | | | 0.178 | 0.065 | 39 |
| PSH 5 | 41.2% | 19.4% | | | | 39.4% | | 0.478 | 0.328 | 40 |
| PSH 6 | 33.2% | 55.4% | | 11.5% | | 0.0% | | 0.203 | 0.059 | 47 |
| PSH 7 | 32.6% | 55.9% | | | 11.4% | | | 0.171 | 0.093 | 55 |
| PSH 8 | 35.7% | 53.4% | | | | 10.9% | | 0.227 | 0.088 | 51 |
| PSH 9 | 33.2% | 38.6% | | 14.1% | 14.1% | | | 0.156 | 0.074 | 53 |
| PSH 10 | 40.5% | 34.5% | | 12.5% | | 12.5% | | 0.253 | 0.093 | 59 |
| PSH 11 | 36.1% | 37.0% | | 13.4% | | | 13.6% | 0.276 | 0.110 | 57 |
| PSH 12 | 38.3% | 35.8% | | | 12.9% | 13.0% | | 0.172 | 0.086 | 45 |
| PSH 13 | 35.3% | 37.6% | | | 13.6% | | 13.6% | 0.191 | 0.099 | 54 |
| PSH 14 | 35.7% | 37.2% | | | | 13.6% | 13.5% | 0.341 | 0.174 | 61 |
| PSH 15 | 33.6% | 35.3% | | | 31.1% | | | 0.201 | 0.081 | 61 |
| PSH 16 | 32.2% | 26.0% | | 27.0% | 14.8% | | | 0.188 | 0.072 | 55 |
| PSH 17 | 33.5% | 16.6% | | 13.0% | 36.9% | | | 0.192 | 0.109 | 58 |
| PSH 18 | 34.0% | 16.5% | | 6.6% | 36.4% | 6.5% | | 0.204 | 0.115 | 47 |
| PSH 19 | 34.7% | 16.5% | | 35.9% | | 12.9% | | 0.181 | 0.070 | 55 |
| PSH 20 | 33.7% | 66.3% | | | | | | 0.172 | 0.067 | 41 |
| PSH 21 | 39.0% | | 61.0% | | | | | 0.428 | 0.094 | 40 |
| PSH 22 | 38.0% | 24.7% | | 31.0% | | 6.2% | | 0.184 | 0.126 | 40 |
| PSH 23 | 37.9% | 40.2% | | 15.5% | | 6.4% | | 0.159 | 0.117 | 40 |
| PSH 24 | 38.6% | | 35.7% | 12.8% | 12.9% | | | 0.187 | 0.048 | 41 |
| PSH 25 | 37.0% | 36.4% | | 13.3% | 13.3% | | | 0.175 | 0.090 | 41 |
| PSH 26 | 31.8% | 16.8% | | 24.3% | 27.1% | | | 0.133 | 0.107 | 41 |
| PSH 27 | 33.8% | 16.7% | | 13.2% | 36.6% | | | 0.201 | 0.102 | 39 |
| PSH 28 | 32.5% | 22.3% | | 15.0% | 30.3% | | | 0.168 | 0.144 | 40 |
| PSH 29 | 32.1% | 27.0% | | 13.7% | 27.2% | | | 0.192 | 0.126 | 41 |
| PSH 31 | 36.1% | 37.0% | | 27.0% | | | | 0.268 | 0.112 | 40 |
| PSH 33 | 36.0% | 37.1% | | 13.4% | 13.5% | | | 0.223 | 0.114 | 40 |

The thermal interface materials were applied to thermal impedance test blocks and tested to give the TI-raw results in Table 1. They were then cured at 30 psi at 150° C. for 30 minutes and retested to give the TI-cured results in Table 1. Curing the thermal interface material reduced the thermal impedance by 25 to 80%. Several of the compositions were measured at different nominal BLTs and their results are in the table below. Such measurement allows calculation of the thermal conductivity of the TIM (Table 2) which is useful in the actual application.

| | Thermal Impedance | | | |
|---|---|---|---|---|
| BLT | (C-cm2/W) | | | Thermal Conductivty |
| (microns) | PSH 6 | PSH 9 | PSH 25 | (W/m-K) |
| 53 | 0.058 | | | 3.85 |
| 71 | 0.091 | | | |
| 84 | 0.140 | | | |
| 49 | | 0.055 | | 6.18 |
| 53 | | 0.075 | | |
| 61 | | 0.084 | | |
| 72 | | 0.086 | | |
| 74 | | 0.098 | | |
| 74 | | 0.107 | | |
| 114 | | 0.167 | | |
| 36 | | | 0.036 | 5.56 |
| 40 | | | 0.060 | |
| 41 | | | 0.054 | |
| 43 | | | 0.041 | |
| 116 | | | 0.195 | |
| 122 | | | 0.187 | |

### Example 3

Example 3 comprises another thermal interface material, which comprises at least one polymer-based carrier matrix as the matrix component, at least one high conductivity component and a solder material. As contemplated, the at least one high conductivity component comprises lattice components, such as reinforcement materials, including screens, mesh, foam, cloth or combinations thereof. Contemplated mesh may comprise copper, silver, gold, indium, tin, aluminum, iron, screen, foam, cloth, graphite, carbon fibers or combinations thereof.

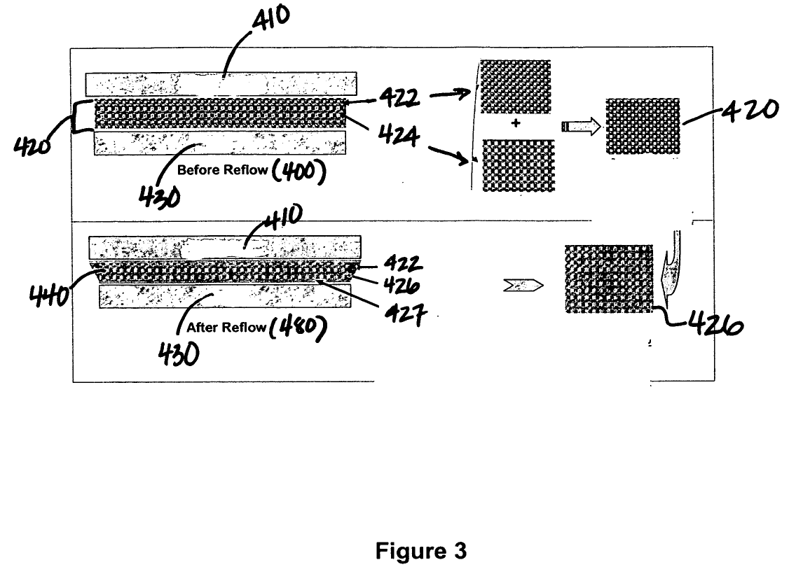

FIG. 3 shows a method of producing these thermal interface materials comprising lattice components. A heat spreader (410) is stacked on top of a layered thermal interface material (420) and a heat generating device, i.e. a silicon-based chip (430). Before reflow (400), the layered thermal interface material (420) comprises a solder/flux or polymer solder hybrid component (422) and a lattice component (424), which is a screen/cloth in this Example. The layered thermal interface material (420) is shown herein (426) as a screen/cloth which is impregnated with a solder material. After reflow (480), the layered thermal interface material (420) becomes the reinforced thermal interface material (440), where the screen/cloth (426) is embedded into the solder component or polymer solder hybrid (422) and forms a metallurgical bonding interface (427) with the silicon-based chip (430).

A contemplated thermal interface material comprises a preform or a tape comprised of a solder component (solder cladding, solder paste, and/or polymer solder hybrid) on the high conductivity components, such as lattice components. For small die (approximately less than 100 mm²) the TIM comprises a solder component and a thermal reinforcement a with minimum BLT, for medium sized die (approximately 100-200 mm²) it comprises a solder component plus surface-activated thermal reinforcements with adjustable bond line thickness, for larger die (approximately larger than 200 mm²) the contemplated TIM comprises a solder component plus a surface-activated thermal reinforcements and flexible frame/foam to separate the TIM into smaller regions. The typical embodiment will comprise 10-100 vol % solder (melting point around 70-220° C.) 0-50 vol % thermal reinforcements with tailorable CTE, and 0-40 vol % flux or heat vaporizable carrier fluid.

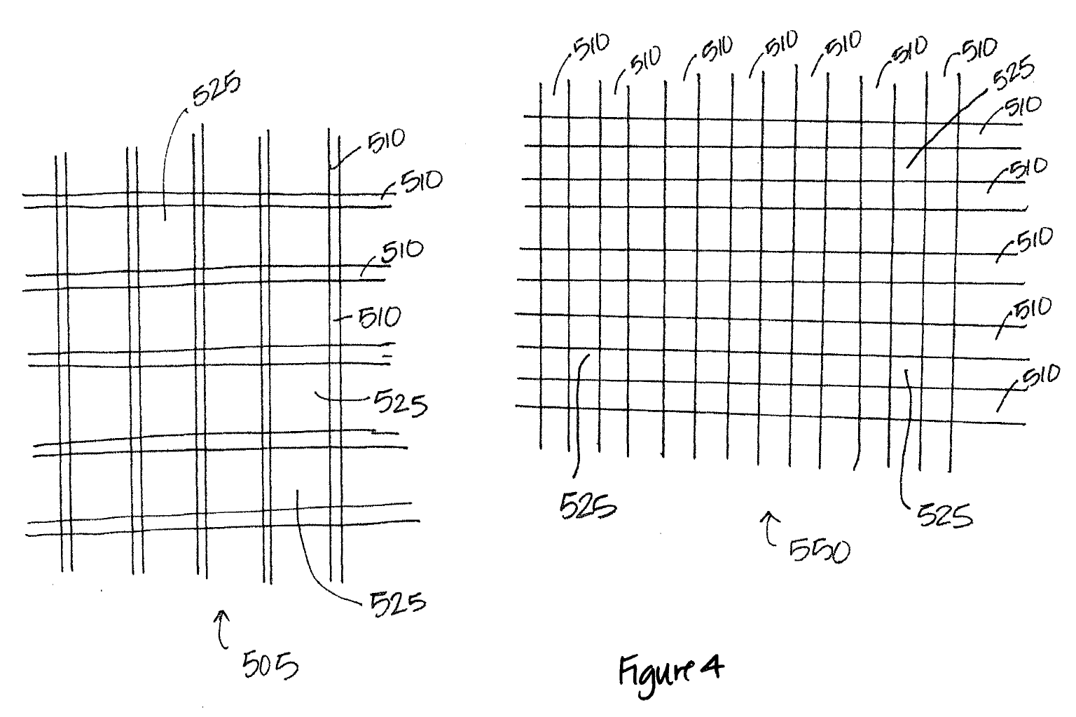

Solders or solder pastes (solder+flux) comprise Sn—Bi or Sn—In eutectics, or other tin and indium based solders, such as those having a melting point around 70-220° C., such as, Sn—Bi—Zn, Sn—In—Zn, Sn—In—Bi—Zn, Sn—Bi—Zn—Cu, Sn—In—Zn—Cu, Sn—In—Bi—Zn—Cu or combinations thereof. Examples were fabricated by combining the following materials and tested as listed in the table below. EFD Bi42Sn solder paste (type I is a washable formulation and type II is a no clean formulation), metallic indium, and Cu Screen prepared according to:
1—2.2 mil wire & 145 mesh, pressed down to 1-2 mil
2—2.2 mil wire & 145 mesh, rolled down to 1-2 mil
3—4.5 mil wire & 100 mesh, pressed down to 3-4 mil
4—4.5 mil wire & 100 mesh, rolled down to 3-4 mil
   FIG. 4 shows a representation of a contemplated embodiment where a lattice component, such as a wire mesh (505), is pressed down to increase surface area of the wires of the mesh (550). The “open area” (525) between the wires (510) is reduced, while at the same time increasing the surface area of the wire. It is contemplated that these lattice components can either be rolled or pressed, as shown above. The TI blocks with the TIM for testing were reflowed at the peak temperature of 170° C. and the results are shown in Table 3.

| Materials | BLT(μm) | TI (C-cm\hat{ }2/W) |
|---|---|---|
| SnBi paste I | 94 | 0.162 |
| SnBi paste I | 12 | 0.029 |
| SnBi paste I + Screen1 | 34 | 0.057 |
| SnBi paste I + Screen1 | 80 | 0.058 |
| SnBi paste I + Screen2 | 32 | 0.067 |
| SnBi paste I + Screen3 | 111 | 0.022 |
| SnBi paste I + Screen3 | 109 | 0.025 |
| SnBi paste II + Screen3 | 105 | 0.019 |
| SnBi paste I + Screen4 | 122 | 0.047 |
| SnBi paste I + 1 mil Cu foil | 42 | 0.108 |
| SnBi paste I + 6.6 wt % Al2O3 | 115 | 0.120 |
| SnBi paste I + 3.3 wt % BN | 29 | 0.102 |
| SnBi paste I + 14 wt % Cu powder | 94 | 0.108 |
| Indium | 185 | 0.023 |
| Indium + Screen3 | 151 | 0.016 |

In addition to an indium preform or tape, alloys such as Sn45Bi1Zn0.5Cu, Bi48.5Sn1Zn0.5Cu, Sn25In5Zn, and other alloys that melt between 70 and 220° C. and that wet the substrates and reinforcements can be used. In addition to the Bi42Sn solder paste, pastes made from Bi42Sn plus 0-2% Zn and/or 0-1% Cu, and other solder alloys that melt between 70 and 220° C. that wet the substrates and reinforcements can be used. These solder pastes typically have solder particle size distributions of 5-15 μm, 20-25 μm, 25-45 μm, and 45-75 μm with particles of less than 45 μm being most advantageous in this application. Both no clean and water soluble fluxes can be used for this application as defined above. A typical no-clean (NC) flux consists of rosin, solvent (tridecyl alcohol, alpha terpineol, and/or petrolatum), and activator. Typical water soluble (WS) flux consists of an organic, a thixotrope, and a solvent.

Thus, specific embodiments and applications of thermal interconnect and interface materials and methods of production have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A thermal interface material, comprising:
at least one matrix component,
at least one high conductivity component, and
at least one solder material.

2. The thermal interface material of claim 1, comprising at least one additional component.

3. The thermal interface material of claim 1, wherein the at least one matrix material comprises a polymer component.

4. The thermal interface material of claim 3, wherein the polymer compound comprises a crosslinkable polymer compound.

5. The thermal interface material of claim 1, wherein the at least one matrix component comprises at least one silicone-based component.

6. The thermal interface material of claim 1, wherein the at least one matrix component comprises a phase change material.

7. The thermal interface material of claim 1, wherein the at least one matrix component comprises a wax.

8. The thermal interface material of claim 1, wherein the at least one matrix material comprises an organic oil.

9. The thermal interface material of claim 8, wherein the at least one organic oil is non-curable.

10. The thermal interface material of claim 8, wherein the at least one organic oil comprises plant-based oils, mineral oils, synthetic oils or a combination thereof.

11. The thermal interface material of claim 1, wherein the at least one high conductivity component comprises at least one filler component, at least one lattice component or a combination thereof.

12. The thermal interface material of claim 11, wherein the at least one filler component comprises silver, copper, aluminum or alloys thereof, boron nitride, aluminum spheres, aluminum nitride, silver-coated copper, silver-coated aluminum, carbon fibers, carbon fibers coated with metals, carbon nanotubes, carbon nanofibers, metal alloys, conductive polymers or other composite materials, metal-coated boron nitride, metal-coated ceramics, diamond, metal-coated diamond, graphite, metal-coated graphite and combinations thereof.

13. The thermal interface material of claim 11, wherein the at least one filler component comprises at least one plurality of particles.

14. The thermal interface material of claim 13, wherein the at least one plurality of particles comprises a median diameter.

15. The thermal interface material of claim 14, wherein the at least one plurality of particles comprises a first plurality of particles having a first median diameter and a second plurality of particles having a second median diameter.

16. The interface material of claim 14, wherein the at least one diameter comprises a median diameter of less than about 40 micrometers.

17. The thermal interface material of claim 11, wherein the lattice component comprises a screen, mesh, foam, cloth or combination thereof.

18. The thermal interface material of claim 17, wherein the mesh comprises copper, silver, gold, indium, tin, aluminum, iron, at least one screen, at least one foam, at least one cloth, graphite, a plurality of carbon fibers or a combination thereof.

19. The thermal interface material of claim 18, wherein the surface area of the lattice component is increased by rolling the lattice component, pressing the lattice component or a combination thereof.

20. The thermal interface material of claim 1, wherein the at least one solder material comprises indium, silver, copper, tin, zinc, bismuth, gallium, gold, magnesium, rare earth elements and combinations thereof.

21. The thermal interface material of claim 20, wherein the solder material comprises pure indium, SnBi alloys, SnInBi alloys, InSnAgZn alloys or combinations thereof.

22. The thermal interface material of claim 20, wherein the at least one solder material comprises at least one plurality of particles.

23. The thermal interface material of claim 22, wherein the at least one plurality of particles comprises a median diameter.

24. The thermal interface material of claim 23, wherein the at least one plurality of particles comprises a first plurality of particles having a first median diameter and a second plurality of particles having a second median diameter.

25. The thermal interface material of claim 23, wherein the at least one solder material comprises solder particles having a median diameter of less than about 40 micrometers.

26. The thermal interface material of claim 20, wherein the at least one solder material comprises a bismuth-tin alloy.

27. The thermal interface material of claim 26, wherein the bismuth-tin alloy comprises about 30-60 wt % tin.

28. The thermal interface material of claim 20, wherein the at least one solder material comprises a tin-indium-bismuth alloy.

29. The thermal interface material of claim 28, wherein the tin-indium-bismuth alloy comprises about 30-80 wt % tin, about 1-50 wt % indium, and about 1-70 wt % bismuth.

30. The thermal interface material of claim 20, wherein the at least one solder material comprises an indium-tin-silver-zinc alloy.

31. The thermal interface material of claim 30, wherein the indium-tin-silver-zinc alloy comprises about 35-65 wt % indium, about 35-65 wt % tin, about 1-10 wt % silver, and about 1-10 wt % zinc.

32. The thermal interface material of claim 1, wherein the material comprises a pre-cure state, a cured state or a combination thereof and wherein each state comprises a thermal impedance.

33. The thermal interface material of claim 32, wherein the thermal impedance of the cured state is less than the thermal impedance of the pre-cure state.

34. The thermal interface material of claim 33, wherein the thermal impedance of the cured state is reduced by at least 25% as compared to the thermal impedance of the pre-cure state.

35. The thermal interface material of claim 33, wherein the thermal impedance of the cured state is reduced by at least 40% as compared to the thermal impedance of the pre-cure state.

36. The thermal interface material of claim 33, wherein the thermal impedance of the cured state is reduced by at least 70% as compared to the thermal impedance of the pre-cure state.

37. The thermal interface material of claim 2, wherein the at least one additional component comprises a wetting agent.

38. A thermal interface material comprising:
at least one matrix component,
at least two different high conductivity components, and
at least one solder material.

39. The thermal interface material of claim 38, wherein the at least two high conductivity components comprises a screen, mesh, foam, particles or combination thereof.

40. The thermal interface material of claim 38, wherein the at least one solder material is clad to at least one of the high conductivity components.

41. The thermal interface material of claim 38, wherein at least one of the high conductivity components has been coated with at least part of the solder material, by plasma spray, by plating, melt dipping, sputtering, or a combination thereof.

42. The thermal interface material of claim 41, wherein plating comprises chemical plating, electrochemical plating, electroless plating or a combination thereof.

43. The thermal interface material of claim 38, wherein the at least part of the solder material is in the molten state.

44. The thermal interface material of claim 38, wherein the at least one solder material comprises a paste that has been coated on at least one of the high conductivity components.

45. The thermal interface material of claim 38, wherein the at least one solder comprises the thermal interface material of claim 1.

46. A method of producing a thermal interface material, comprising
providing at least one matrix component,
providing at least one high conductivity component,
providing at least one solder material, and
blending the at least one matrix component, the at least one high conductivity component and the at least one solder material.

47. The method of claim 46, comprising at least one additional component.

48. The method of claim 46, wherein the at least one matrix material comprises a polymer compound.

49. The method of claim 48, wherein the polymer compound comprises a crosslinkable polymer compound.

50. The method of claim 46, wherein the at least one matrix component comprises a silicone-based component.

51. The method of claim 46, wherein the at least one matrix material comprises an organic oil.

52. The method of claim 51, wherein the at least one organic oil is non-curable.

53. The method of claim 51, wherein the at least one organic oil comprises plant-based oils, mineral oils, synthetic oils or a combination thereof.

54. The method of claim 46, wherein the at least one high conductivity component comprises silver, copper, aluminum or alloys thereof, boron nitride, aluminum spheres, aluminum nitride, silver-coated copper, silver-coated aluminum, carbon fibers, carbon fibers coated with metals, carbon nanotubes, carbon nanofibers, metal alloys, conductive polymers or other composite materials, metal-coated boron nitride, metal-coated ceramics, diamond, metal-coated diamond, graphite, metal-coated graphite and combinations thereof.

55. The method of claim 46, wherein the at least one solder material comprises indium, silver, copper, tin, bismuth and combinations thereof.
